(19) United States
(12) Patent Application Publication
(10) Pub. No.: US 2026/0102653 A1
(43) Pub. Date: Apr. 16, 2026

(54) EXERCISE CYCLE WITH DESKTOP FOR PLAYING CONSOLE VIDEO GAMES

(71) Applicant: Gamer Cycle Fitness Inc., Cochrane (CA)

(72) Inventor: Adam Christian Holynaty, Cochrane (CA)

(21) Appl. No.: 18/916,825

(22) Filed: Oct. 16, 2024

(51) Int. Cl. A63B 22/06; A63B 22/00; A63B 71/06; A63F 13/90

(52) U.S. Cl. CPC A63B 22/0605; A63B 22/0023; A63B 71/0622; A63F 13/90

(57) ABSTRACT

An exercise cycle includes a frame having a front and a rear, and a seat supported on the frame toward the rear. The seat is configured for a user to sit facing in a direction toward the front of the frame. A desk platform is supported on the frame between the seat and the front of the frame. The desk platform has a first portion that is horizontally oriented, and a second portion disposed between the first portion and the seat. The second portion is angled downwardly at an angle of approximately 10 to 15 degrees relative to the first portion. The exercise cycle further has pedals, and the pedals and seat are positioned to provide a pedal angle of approximately 25 to 45 degrees to the user when the user is seated on the seat.

### FIELD OF THE INVENTION

The present invention generally relates to the field of exercise equipment and gaming systems and, more particularly, relates to an exercise cycle with a desktop configured to permit playing video games on console game systems while exercising.

### BACKGROUND OF THE INVENTION

People are becoming increasingly sedentary, which contributes to obesity, poor posture, and numerous health issues such as diabetes, cancer, heart disease, and premature death. This trend is especially concerning among those who frequently play video games (referred to here as Gamers). Despite the dangers of a sedentary lifestyle, the average Gamer spends 8.5 hours per week playing video games, often leaving little time for exercise. Video gaming burns very few calories, and Gamers typically sit in poor posture, adopting comfortable positions that ultimately lead to long-term posture problems.

Regular exercise on a stationary bicycle has been shown to reduce body fat, improve overall fitness, and lower the risk of lifestyle-related diseases, including early death. However, many people find stationary cycling monotonous, making it less likely they will engage in it consistently enough to achieve these health benefits.

Combining a stationary cycle with a system that allows Gamers to play their favorite console video games while exercising can make physical activity more attractive and accessible to them. The enjoyment of playing their favorite game replaces the need for external motivation to exercise, leading to more consistent workouts and better health outcomes. Additionally, incorporating physical activity into gaming can enhance the overall immersion and enjoyment of the game.

Previous efforts have been made to harness the appeal of video games to make exercise more enjoyable and accessible. These attempts aimed to enhance the exercise experience by incorporating video game elements to create a more immersive workout, such as simulating a bike race while using a stationary bike. However, these proprietary game-like simulations have failed to capture the interest of the average Gamer, who typically prefers to play the latest big-budget, mainstream video games.

Accordingly, there is both a need and a desire for a new exercise cycle that is configured to permit exercising while playing console video games.

### SUMMARY OF THE INVENTION

This disclosure describes an exercise cycle with a desktop for playing console games.

In some aspects, an exercise cycle includes a frame having a front and a rear, and a seat supported on the frame toward the rear. The seat is configured for a user to sit facing in a direction toward the front of the frame. A desk platform is supported on the frame between the seat and the front of the frame. The desk platform has a first portion that is horizontally oriented, and a second portion disposed between the first portion and the seat. The second portion is angled downwardly at an angle of approximately 10 to 15 degrees relative to the first portion. The exercise cycle further has pedals, and the pedals and seat are positioned to provide a pedal angle of approximately 25 to 45 degrees to the user when the user is seated on the seat.

These and other aspects can include one or more of the following features. The exercise cycle can further include a forearm pad disposed on the second portion of the desk platform. The exercise cycle can further include a controller, and the control can be disposed on the second portion of the desk platform to one side of the forearm pad.

The exercise cycle can further include a game console, a video screen, the game console and video screen can be disposed on the first portion of the desk platform. The frame can have a longitudinal frame rail, a front lateral frame rail, and a rear lateral frame rail. The longitudinal frame rail can extend between the front and rear of the frame, the front lateral frame rail can extend laterally across the front of the frame and attached to the front of the longitudinal frame rail, and the rear lateral frame rail can extend laterally across the rear of the frame and attached to the rear of the longitudinal frame rail.

The frame can have a seat track supported by the seat support and oriented in a direction front to rear of the frame. The seat track can be inclined in a direction from the front to the back of frame. A seat carrier can be slidably coupled to the seat track for selective positioning along a length of the seat track. The seat can be coupled to the seat track so that the seat can be slidably positioned along the track, and the seat has a seat platform and a seat back.

The exercise cycle can further have an angle adjustment bracket attached to a back of the seat back. An extension arm can be attached at one end to the angle adjustment bracket and extend outwardly therefrom in a rearward direction. A vertical seat back post can be attached to the seat carrier rearwardly of the seat platform and the extension arm can be slidably coupled to the seat back post to adjust the forward and aft position of the seat back relative to the seat platform.

The frame can have a vertical desk post attached to the frame at a position forwardly of the seat support, a desk rail slidingly attached to the desk post, and the desk platform can be attached to the desk rail.

In certain instances, an exercise cycle includes a frame having a front and a rear, and a seat supported on the frame toward the rear. The seat is configured for a user to sit facing in a direction toward the front of the frame. A desk platform is supported on the frame between the seat and the front of the frame. The desk platform has a first portion that is horizontally oriented, and a second portion disposed between the first portion and the seat. The second portion is angled downwardly at an angle of approximately 10 to 15 degrees relative to the first portion. The exercise cycle further has pedals, and the pedals and seat are positioned to provide a pedal angle of approximately 25 to 45 degrees to the user when the user is seated on the seat. The seat positions a user's torso at an angle of approximately 80 to 100 degrees relative to a seat platform of the seat.

For the purposes of summarizing the invention, certain aspects, advantages, and novel features of the invention have been described herein. It is to be understood that not necessarily all such advantages can be achieved in accordance with any one embodiment of the invention. Thus, the invention may be embodied or carried out in a manner that achieves or optimizes one advantage or group of advantages as taught herein without necessarily achieving other advantages as may be taught or suggested herein. The features of the invention, which are believed to be novel, are particularly pointed out and distinctly claimed in the concluding portion of the specification. These and other features, aspects, and advantages of the present invention will become better understood with reference to the following drawings and detailed description.

Numerous additional objects, features, and advantages of the present invention will be readily apparent to those of ordinary skill in the art upon a reading of the following detailed description of presently preferred but illustrative embodiments of the present invention when taken in conjunction with the accompanying drawings. The invention is not limited to a single application but is capable of various embodiments and of being practiced and carried out in numerous ways. Also, it is to be understood that the phraseology and terminology employed herein are for descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

For a better understanding of the invention, its operating advantages, and the specific objects attained by its uses, reference should be made to the accompanying drawings and descriptive matter in which there are illustrated embodiments of the invention.

### BRIEF DESCRIPTION OF THE DRAWINGS

The following drawings illustrate by way of example and are included to provide a further understanding of the invention for illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 is a first top perspective view of an exercise cycle with desktop for playing console games according to an embodiment of the disclosure;

FIG. 2 is a second top perspective view of the exercise cycle;

FIG. 3 is a first bottom perspective view of the exercise cycle;

FIG. 4 is a second bottom perspective view of the exercise cycle; and

FIG. 5 is a side view of the exercise cycle.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized, and changes can be made without departing from the scope of the disclosure.

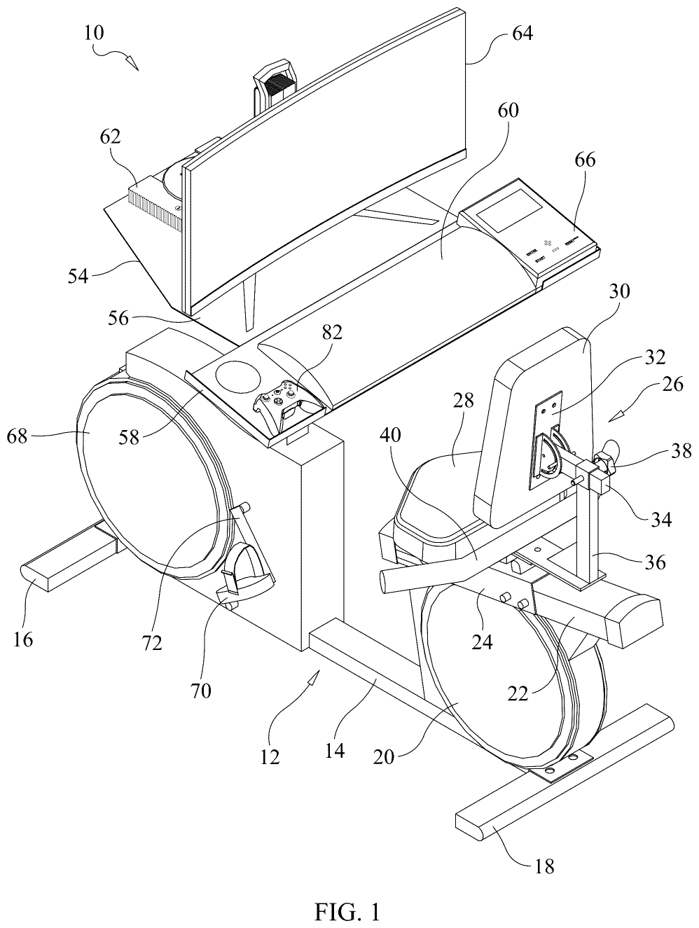

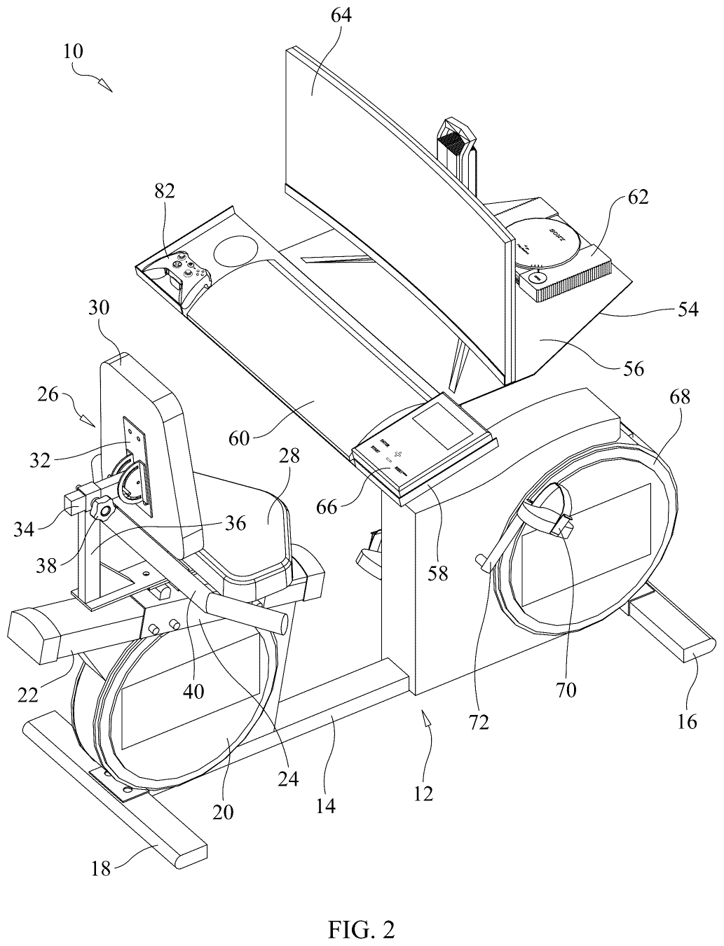

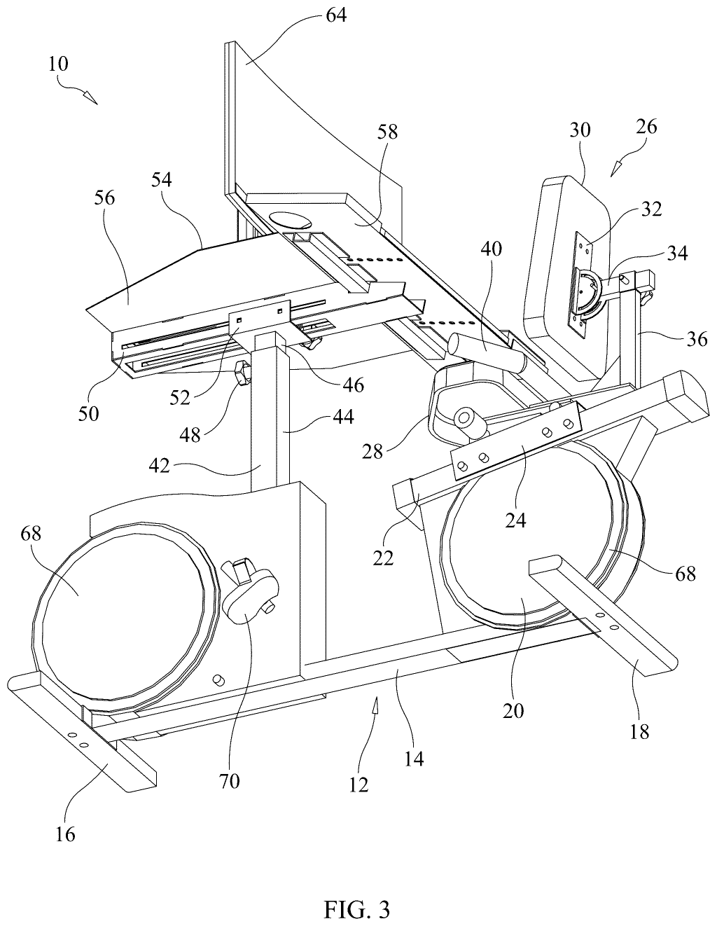

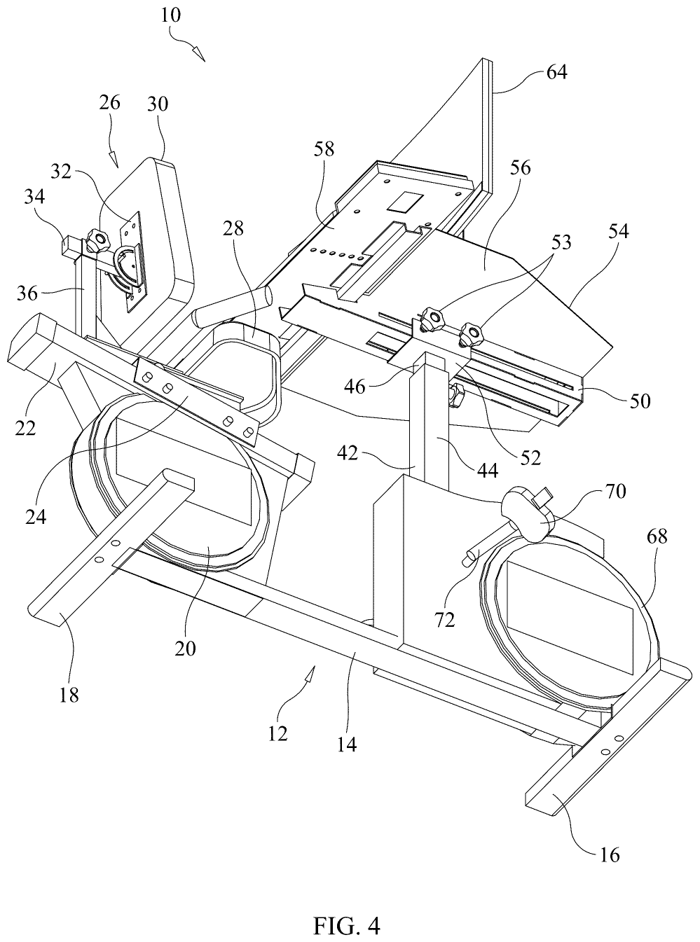

Referring to FIGS. 1-5 of the drawings, there are shown various views of a stationary exercise cycle 10 in accordance with an embodiment of the invention. As will become apparent herein, cycle 10 is specifically configured for a user to exercise using the cycle and simultaneously play console video games by providing a particular structural arrangement for such purpose.

Cycle 10 has a frame 12 that may have a longitudinal frame rail 14, a front lateral frame rail 16, and a rear lateral frame rail 18. The longitudinal frame rail 14 may be oriented to run from front to rear adjacent to a floor surface. The front lateral frame rail 16 may be oriented to run laterally across the front of the frame and attached to the front of the longitudinal frame rail 14. The rear lateral frame rail 18 may be oriented to run laterally across the rear of the frame and attached to the rear of the longitudinal frame rail 14. The longitudinal frame rail 14, the front lateral frame rail 16, and the rear lateral frame rail 18 may be configured to support the frame on the floor surface.

Frame 12 further has a vertical seat support 20 that is attached to the rear of the frame. A seat track 22 is supported by the seat support 20 and is oriented in a direction front to rear of the frame 12. The seat track 22 is inclined in a direction from the front to the back of frame 12. A seat carrier 24 is slidably coupled to the seat track 22 for selective positioning along the length of the seat track. A seat 26 is coupled to the seat track 22 so that the seat can be slidably positioned along the track. Seat 26 has a seat platform 28 and a seat back 30 and is adapted for a user to sit on.

The seat back 30 may be adjustably supported for angle and height adjustments relative to the seat platform 28. An angle adjustment bracket 32 is attached to the back of the seat back 30, an extension arm 34 is attached at one end to the angle adjustment bracket and extends outwardly therefrom in a rearward direction. A vertical seat back post 36 is attached to the seat carrier 24 rearwardly of the seat platform 28. The extension arm 34 is slidably coupled to the top of the seat back post 36 to adjust the forward and aft position of the seat back 30 relative to the seat platform 28. The seat back position may be secured by a seat back lock 38 that engages the extension arm 34.

A handlebar 40 may be attached to the seat carrier 24 and may have forwardly angled hand griping portions at the opposite ends of the handlebar for griping by a user while seated on seat 26.

Frame 12 further has as a vertical desk post 42 attached to the frame at a position forwardly of the seat support 20. Desk post 42 may have an outer post 44 and an inner post 46 that is slidably received within the outer post for telescopic length adjustment of the desk post. Lock 48 may be provided to secure the relative position of posts 44 and 46 to selectively retain the desired length of desk post 42. A desk rail 50 may be slidingly attached to the end of the desk post 42 (at the end of inner post 46) by bracket 52.

A desk platform 54 is attached to the top of the desk rail 50. Desk platform 54 has a first desk portion 56 that is horizontally oriented and a second desk portion 58 that extends in a direction rearwardly toward the rear of frame 12 and is angled downwardly relative to the first desk portion. The angled portion 58 extends laterally across frame 12 and is configured as an armrest for a user. A forearm pad 60 is supported by the second desk portion 58. The first desk portion 56 is configured to support a game console 62 and a video monitor 64, as shown. The heigh of desk platform 54 relative to a user seated on seat 26 may be adjusted by adjusting the length of the desk post 42. The longitudinal position of desk platform 54 (i.e., its position toward or away from a user seated on seat 26) may be adjusted by sliding the desk platform via the desk rail 50 along bracket 52 and secured in position by one or more locks 53.

Cycle 10 may also have a cycle controller 66 that is positioned on the angled portion (armrest) 58 to the side of the forearm pad 60, representatively shown positioned to the right of the forearm pad. The cycle controller 66 is positioned here to prevent visual obstruction of monitor 64 by a user and to prevent distractions from the user while playing video games.

A front housing 68 may be attached to frame 12 at the front thereof. The front housing 68 may cover mechanical components of the cycle to prevent injuries. Foot pedals 70 are located to the left and right of the front housing 68. Pedals 70 are coupled to a crank arm 72 such that pedals may be moved in a circular motion. A brake (not shown) may be provided in the front housing 68 and may resist motion of the pedals 70. As non-limiting examples, the brake may utilize mechanical friction or electromagnetic forces to resist the motion of the pedals 70. In some embodiments, the amount of resistance provided by the brake may be variable and under control of the controller 66. The rotational position of the pedals 70 may also be sensed by the controller 66.

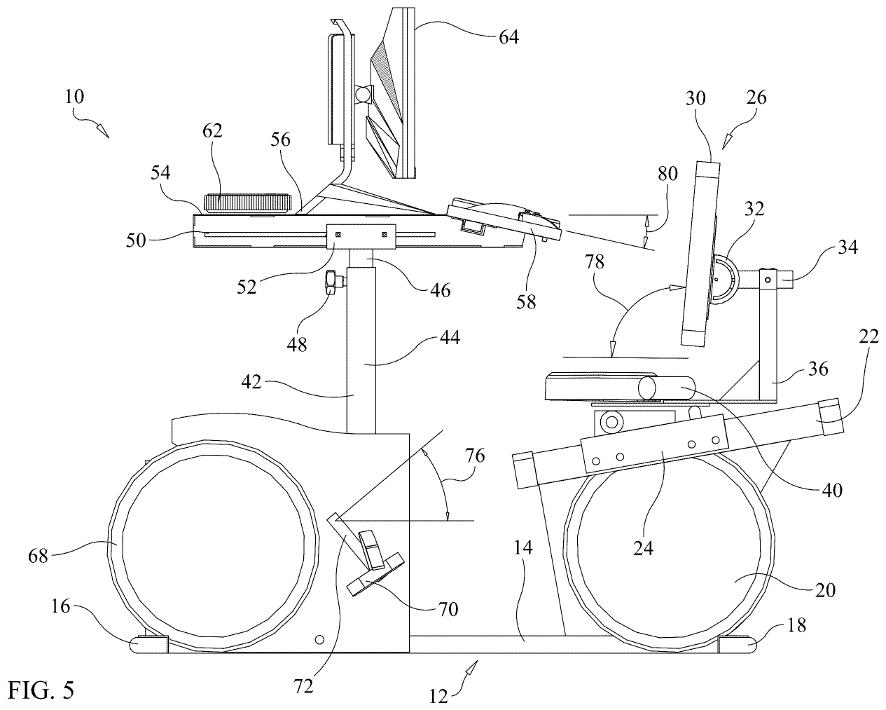

With particular reference to FIG. 5, critical aspects of cycle 10 are found in the relative positions of the various components, including the seat 26, the desk platform 54, and the pedals 70 for positioning a user in a particular posture that is suitable for playing console games with game controller 82 while simultaneously cycling with pedals 70. Particularly, cycle 10 has a steep pedal angle 76 that is approximately 25 to 40 degrees, and seat 26 is to be adjusted so that a user's torso is angled and has a torso angle 78 between approximately 80 and 100 degrees to the floor or the seat platform. Further, the angled portion 58 (armrest) has an angle 80 between approximately 10 to 15 degrees relative to the horizontal portion 56 of the desk platform 54 so that the forearms are supported with the shoulders angled between 45 and 80 degrees from spine.

The angled armrest 58 elevates the user's arms above the legs, while the steep pedal angle (angle 76) lowers the legs, making it possible to pedal unobstructed by the desk platform 54. The adjustable seat 26 and armrest 58 work together to center the user's body weight over the user's hips on the seat. The arms supported by the armrest 58 serve as additional points of contact, increasing upper body stability and making it possible to hold a video game controller and play video games unimpeded by the pedaling motion. The desktop design allows the user to place the screen at eye level, promoting positive head, neck, and spine alignment. The desktop is adjustable in both height and distance relative to the user via one steel telescopic tube and bracket that is attached to the frame, allowing the rider to position the screen at a distance between 12 and 30 inches from the user's eyes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An exercise cycle comprising:
a frame having a front and a rear;
a seat supported on the frame toward the rear, the seat configured for a user to sit on facing in a direction toward the front of the frame;
a desk platform supported on the frame between the seat and the front of the frame, the desk platform having a first portion that is horizontally oriented, and a second portion disposed between the first portion and the seat, the second portion angled downwardly an angle of approximately 10 to 15 degrees relative to the first portion;
pedals; and
wherein the pedals and seat are positioned to provide a pedal angle of approximately 25 to 45 degrees to the user when the user is seated on the seat.

2. The exercise cycle of claim 1, further comprising:
a forearm pad disposed on the second portion of the desk platform.

3. The exercise cycle of claim 2, further comprising:
a controller, the control disposed on the second portion of the desk platform to one side of the forearm pad.

4. The exercise cycle of claim 1, further comprising:
a game console;
a video screen; and
wherein the game console and video screen are disposed on the first portion of the desk platform.

5. The exercise cycle of claim 1, wherein the frame has a longitudinal frame rail, a front lateral frame rail, and a rear lateral frame rail, the longitudinal frame rail extending between the front and rear of the frame, the front lateral frame rail extending laterally across the front of the frame and attached to the front of the longitudinal frame rail, and the rear lateral frame rail extending laterally across the rear of the frame and attached to the rear of the longitudinal frame rail.

6. The exercise cycle of claim 1, wherein:
the frame further has a vertical seat support;
a seat track supported by the seat support and oriented in a direction front to rear of the frame, the seat track inclined in a direction from the front to the back of frame;
a seat carrier slidably coupled to the seat track for selective positioning along a length of the seat track; and
a seat coupled to the seat track so that the seat can be slidably positioned along the track, and the seat has a seat platform and a seat back.

7. The exercise cycle of claim 6, further comprising:
an angle adjustment bracket attached to a back of the seat back;
an extension arm attached at one end to the angle adjustment bracket and extending outwardly therefrom in a rearward direction; and
a vertical seat back post attached to the seat carrier rearwardly of the seat platform, the extension arm slidably coupled to the seat back post to adjust the forward and aft position of the seat back relative to the seat platform.

8. The exercise cycle of claim 1, wherein:
the frame further has a vertical desk post attached to the frame at a position forwardly of the seat support;
a desk rail slidingly attached to the desk post; and
the desk platform attached to the desk rail.

9. An exercise cycle comprising:
a frame having a front and a rear;
a seat supported on the frame toward the rear, the seat configured for a user to sit on facing in a direction toward the front of the frame;
a desk platform supported on the frame between the seat and the front of the frame, the desk platform having a first portion that is horizontally oriented, and a second portion disposed between the first portion and the seat, the second portion angled downwardly an angle of approximately 10 to 15 degrees relative to the first portion;
pedals;
wherein the pedals and seat are positioned to provide a pedal angle of approximately 25 to 45 degrees to the user when the user is seated on the seat; and
wherein the seat positions a user's torso at an angle of approximately 80 to 100 degrees relative to a seat platform of the seat.

10. The exercise cycle of claim 9, wherein:
the frame further has a vertical seat support;
a seat track supported by the seat support and oriented in a direction front to rear of the frame, the seat track inclined in a direction from the front to the back of frame;
a seat carrier slidably coupled to the seat track for selective positioning along a length of the seat track;
a seat coupled to the seat track so that the seat can be slidably positioned along the track, and the seat has a seat platform and a seat back;
an angle adjustment bracket attached to a back of the seat back;
an extension arm attached at one end to the angle adjustment bracket and extending outwardly therefrom in a rearward direction; and
a vertical seat back post attached to the seat carrier rearwardly of the seat platform, the extension arm slidably coupled to the seat back post to adjust the forward and aft position of the seat back relative to the seat platform.

11. The exercise cycle of claim 9, wherein:
the frame further has a vertical desk post attached to the frame at a position forwardly of the seat support, the vertical desk post being telescopic;
a desk rail slidingly attached to the desk post; and
the desk platform attached to the desk rail.

12. The exercise cycle of claim 9, wherein the frame has a longitudinal frame rail, a front lateral frame rail, and a rear lateral frame rail, the longitudinal frame rail extending between the front and rear of the frame, the front lateral frame rail extending laterally across the front of the frame and attached to the front of the longitudinal frame rail, and the rear lateral frame rail extending laterally across the rear of the frame and attached to the rear of the longitudinal frame rail.

13. The exercise cycle of claim 9, further comprising:
a game console;
a video screen; and
wherein the game console and video screen are disposed on the first portion of the desk platform.

14. The exercise cycle of claim 9, further comprising:
a forearm pad disposed on the second portion of the desk platform.

15. The exercise cycle of claim 14, further comprising:
a controller, the control disposed on the second portion of the desk platform to one side of the forearm pad.
